(19) United States
(12) Patent Application Publication
(10) Pub. No.: US 2026/0162400 A1
(43) Pub. Date: Jun. 11, 2026

(54) IMAGE PROCESSING DEVICE, IMAGE PROCESSING METHOD, AND PROGRAM

(71) Applicant: NIPPON TELEGRAPH AND TELEPHONE CORPORATION, Tokyo (JP)

(72) Inventors: Daisuke UCHIBORI, Tokyo (JP); Wataru ITO, Tokyo (JP); Kazuaki WATANABE, Tokyo (JP); Yosuke SAKURADA, Tokyo (JP); Atsushi ARATAKE, Tokyo (JP)

(73) Assignee: NIPPON TELEGRAPH AND TELEPHONE CORPORATION, Tokyo (JP)

(21) Appl. No.: 18/710,255

(22) PCT Filed: Nov. 17, 2021
(86) PCT No.: PCT/JP2021/042299

§ 371 Date: May 15, 2024

(51) Int. Cl. G06V 10/62; G06V 10/24; G06V 10/25; G06V 20/17

(52) U.S. Cl. CPC G06V 10/62; G06V 10/242; G06V 10/25; G06V 20/17

(57) ABSTRACT

An image processing apparatus (10) according to the present disclosure includes: a feature point detection unit (12) configured to detect feature points in a first frame that is a frame at a first time serving as a base point and a second frame that is a frame at a second time after a predetermined time has elapsed from the first time; an overlapping unit (13) configured to overlap the first frame and the second frame so that the distance between corresponding feature points in the first frame and the second frame is minimized; and an overlap ratio determination unit (14) configured to determine whether or not the ratio of the area of an overlap region where the first frame and the second frame overlap, to the area of the first frame, is equal to or less than a predetermined threshold value, and output the second frame as the cut-out frame if the ratio is determined to be equal to or less than the predetermined threshold value.

### TECHNICAL FIELD

The present invention relates to an image processing apparatus, an image processing method, and a program.

### BACKGROUND ART

Recently, in order to efficiently inspect a large infrastructure structure such as a road bridge or a road tunnel, a method has been used in which an unmanned aerial vehicle (UAV) is made to fly around the infrastructure structure, the infrastructure structure is photographed by a photographing device mounted on the UAV, and an inspector visually confirms a photographed moving image. After confirmation by the moving image, the inspector usually creates a report of an inspection result including a still image cut out from the moving image. In this case, in order to easily grasp the state of the infrastructure structure, it is desirable to cut out a frame as a still image from the moving image every time an arbitrary portion of the infrastructure moves by a certain amount in the moving image, so that the portions of the infrastructure structure do not overlap.

Various methods have been proposed for outputting a specific frame as a still image from a moving image. For example, NPL 1 and 2 describe a method of outputting a frame as a still image at the timing when it is detected that an object photographed within an angle of view of a moving image photographed with a fixed viewpoint of a photographing device has moved by a fixed amount. In addition, NPL 3 and 4 describe a method of detecting a frame as a still image at the timing when a specific object, such as an airplane, ship, or bus, is reflected in an angle of view or when a specific motion, such as an eating motion, is detected.

### CITATION LIST

### Non Patent Literature

[NPL 1] Norimichi Idehara, Fumiaki Sugita, Development of Automatic Keyframe Extraction and Distribution System in Video, Journal of Management and Information Sciences, Tama University, pp. 195-198, 2015.
[NPL 2] Shinya Takahashi, Sakashi Maeda, Koji Hashimoto, Naoyuki Tsuruta, and Hiroyuki Ai, A study of a method of detecting honeybee waggle dance based on inter-frame difference images, Fukuoka University review of technological sciences, pp. 75-80, 2018.
[NPL 3] Hayato Kobayashi, Keiji Yanai, Automatic detection of specific motion scenes from TV image, DEIM Forum, E5-6, 2016.
[NPL 4] Kazuya Hizume, Keiji Yanai, Analysis of video recognition using multi-frame recognition, Research Report Computer Vision and Image Media, pp. 1-8, 2011.

### SUMMARY OF INVENTION

### Technical Problem

The methods described in NPL 1 and 2 are for a moving image with a fixed photographing viewpoint. Therefore, when photographing is performed while the viewpoint is moving, all the objects in the field angle move, making it difficult to apply the methods described in NPL 1 and 2. In addition, since the structure is uniform and does not accompany operation in a moving image obtained by photographing the infrastructure structure, it is difficult to apply a method for detecting a specific object or motion, such as the methods described in NPL 3 and 4.

An object of the present disclosure, which has been made in view of the above-mentioned problems, is to provide an image processing apparatus, an image processing method, and a program that can output a frame at the timing when a predetermined portion of an object is displaced by a predetermined amount in a moving image obtained by photographing the object while moving the viewpoint.

### Solution to Problem

In order to solve the above problems, an image processing apparatus according to the present disclosure is an image processing apparatus that outputs, as a cut-out frame, a frame at a timing when a predetermined portion of an object is displaced by a predetermined amount in a moving image consisting of a plurality of frames and obtained by photographing the object while moving a viewpoint, the image processing apparatus including: a feature point detection unit configured to detect feature points in a first frame that is a frame at a first time serving as a base point and a second frame that is a frame at a second time after a predetermined time has elapsed from the first time; an overlapping unit configured to overlap the first frame and the second frame so that a distance between corresponding feature points in the first frame and the second frame is minimized; and an overlap ratio determination unit configured to determine whether or not a ratio of an area of an overlap region where the first frame and the second frame overlap, to an area of the first frame, is equal to or less than a predetermined threshold value, and output the second frame as the cut-out frame if the ratio is determined to be equal to or less than the predetermined threshold value.

In addition, in order to solve the above problems, an image processing method according to the present disclosure is an image processing method for outputting, as a cut-out frame, a frame at a timing when a predetermined portion of an object is displaced by a predetermined amount in a moving image consisting of a plurality of frames and obtained by photographing the object while moving a viewpoint, the image processing method including the steps of: detecting feature points in a first frame that is a frame at a first time serving as a base point and a second frame that is a frame at a second time after a predetermined time has elapsed from the first time; overlapping the first frame and the second frame so that a distance between corresponding feature points in the first frame and the second frame is minimized; and determining whether or not a ratio of an area of an overlap region where the first frame and the second frame overlap, to an area of the first frame, is equal to or less than a predetermined threshold value, and outputting the second frame as the cut-out frame if the ratio is determined to be equal to or less than the predetermined threshold value.

In addition, in order to solve the above problems, a program according to the present disclosure causes a computer to operate as the image processing apparatus described above.

### Advantageous Effects of Invention

According to the image processing apparatus, the image processing method, and the program according to the present disclosure, it is possible to output frames at the timing when a predetermined portion of an object is displaced by a predetermined amount in a moving image obtained by photographing the object while moving the viewpoint.

### BRIEF DESCRIPTION OF DRAWINGS

FIG. 1 is a diagram showing an example of a configuration of an image processing apparatus according to a first embodiment of the present disclosure.

FIG. 2A is a diagram showing an example of a detection result of a feature point in a base point time frame by a base point time feature point detection unit shown in FIG. 1.

FIG. 2B is a diagram showing an example of a detection result of a feature point in an elapsed time frame by an elapsed time feature point detection unit shown in FIG. 1.

FIG. 3 is a diagram for explaining an overlap of a base point time frame and an elapsed time frame by an overlapping unit shown in FIG. 1.

FIG. 4 is a diagram for explaining determination of an overlap ratio by an overlap ratio determination unit shown in FIG. 1.

FIG. 5 is a flow chart showing an example of an operation of an image processing apparatus shown in FIG. 1.

FIG. 6 is a diagram showing an example of a hardware configuration of the image processing apparatus shown in FIG. 1.

FIG. 7 is a diagram showing an example of a configuration of an image processing apparatus according to a second embodiment of the present disclosure.

FIG. 8A is a diagram showing an example of setting of a feature point detection region in a base point time frame by a feature point detection region setting unit 1231 shown in FIG. 7.

FIG. 8B is a diagram showing an example of setting of a feature point detection region in an elapsed time frame by a feature point detection region setting unit 1241 shown in FIG. 7.

FIG. 9 is a diagram showing an example of a configuration of an image processing apparatus according to a third embodiment of the present disclosure.

FIG. 10 is a diagram for explaining a movement/rotation/scale change of the elapsed time frame by a movement/rotation/scale change unit shown in FIG. 9.

FIG. 11 is a diagram showing an example of a configuration of an image processing apparatus according to a fourth embodiment of the present disclosure.

### DESCRIPTION OF EMBODIMENTS

Embodiments of the present disclosure will be described hereinafter with reference to the drawings.

### First Embodiment

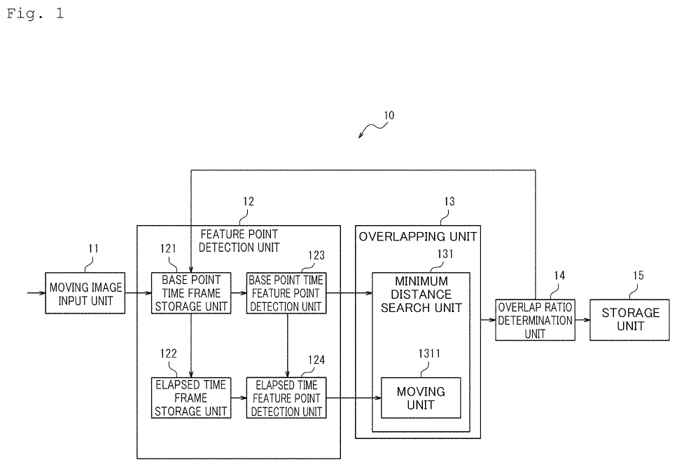

FIG. 1 is a diagram showing an example of a configuration of an image processing apparatus 10 according to a first embodiment of the present disclosure. The image processing apparatus 10 according to the present embodiment outputs, as a cut-out frame, a frame at the timing at which a predetermined portion of an object is displaced by a predetermined amount in a moving image obtained by photographing the object such as an infrastructure structure while moving a viewpoint by a photographing device mounted on a UAV or the like.

As shown in FIG. 1, the image processing apparatus 10 according to the present embodiment includes a moving image input unit 11, a feature point detection unit 12, an overlapping unit 13, an overlap ratio determination unit 14, and a storage unit 15.

The moving image input unit 11 receives an input of a moving image photographed by a photographing device such as a digital video camera. The moving image is obtained by photographing an object such as an infrastructure structure by a photographing device mounted on a movable body such as a UAV while moving a viewpoint, and is composed of a plurality of frames (still images) arranged in chronological order. The resolution and frame rate of the moving image input to the moving image input unit 11 are arbitrary. The moving image input unit 11 outputs the input moving image to the feature point detection unit 12.

The feature point detection unit 12 detects feature points in a base point time frame (first frame) that is a frame at a base point time (first time) that is a time to be a base point in a moving image output from the moving image input unit 11, and an elapsed time frame (second frame) that is a frame at an elapsed time (second time) that is a predetermined time elapsed from the base point time. The feature point detection unit 12 includes a base point time frame storage unit 121, an elapsed time frame storage unit 122, a base point time feature point detection unit 123, and an elapsed time feature point detection unit 124.

A moving image is input from the moving image input unit 11 to the base point time frame storage unit 121. With an arbitrary time t1 as a base point time, the base point time frame storage unit 121 stores a frame constituting a moving image at the time t1 as the base point time frame. The base point time frame storage unit 121 outputs the moving image input from the moving image input unit 11 to the elapsed time frame storage unit 122.

The moving image is input to the elapsed time frame storage unit 122 from the base point time frame storage unit 121. The elapsed time frame storage unit 122 stores a frame constituting the moving image at an elapsed time after a predetermined time Δt elapses from the time t1 (base point time), as the elapsed time frame. The elapsed time frame storage unit 122 may store an arbitrary number of elapsed time frames. For example, the elapsed time frame storage unit 122 may store frames as the elapsed time frames at each of a plurality of times when different times have elapsed from the base point time, such as t1+Δt, t1+Δt1, t1+Δt2, and the like. The elapsed time frame storage unit 122 can store a plurality of elapsed time frames different in elapsed time from the base point time as long as a frame of a moving image exists.

As described above, the elapsed time frame is a frame at a time when a predetermined time Δt has elapsed from the base point time. By defining the elapsed time frame as a frame occurring later in time series than the base point time frame, a frame at a time before the base point time is prevented from being stored as the elapsed time frame. Thus, the frame can be processed along the photographed time series. Further, since it is not necessary to process a frame at a time before the base point time by processing the frames in chronological order, the amount of calculation can be reduced.

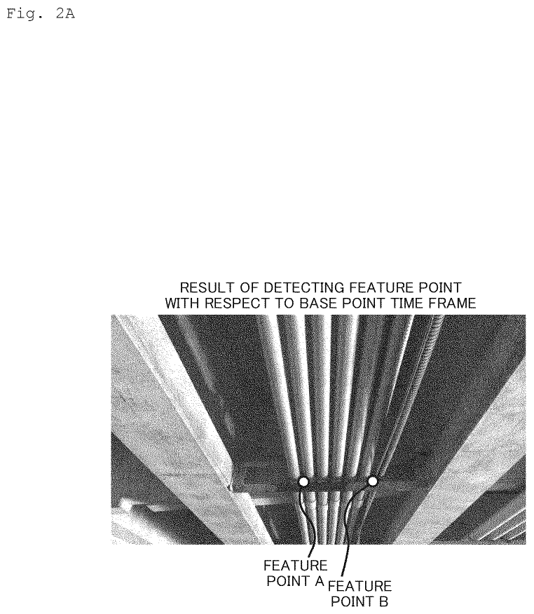

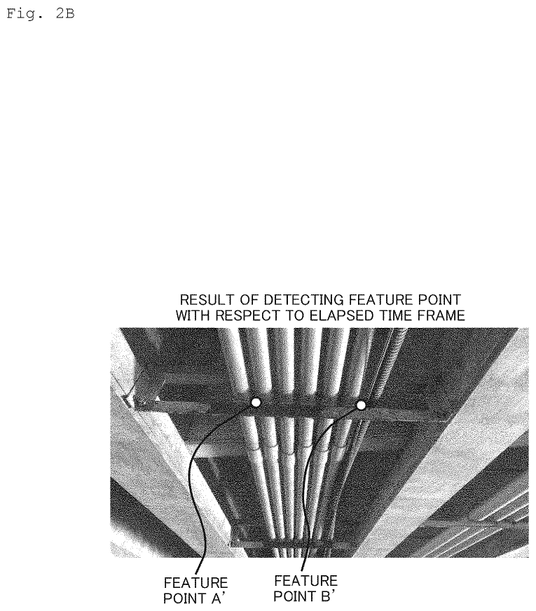

The base point time feature point detection unit 123 detects a feature point in the base point time frame stored by the base point time frame storage unit 121, as shown in FIG. 2A. The feature point is, for example, a pixel having luminance of color information satisfying a certain condition in a frame (still image). The feature point is, for example, a pixel whose feature amount calculated from luminance or color gradient information around a certain pixel satisfies a certain condition. The base point time feature point detection unit 123 detects at least one or more feature points.

The elapsed time feature point detection unit 124 detects a feature point in the elapsed time frame stored by the elapsed time frame storage unit 122 as shown in FIG. 2B. The elapsed time feature point detection unit 124 detects a feature point for each of a plurality of elapsed time frames when the plurality of elapsed time frames are stored.

The overlapping unit 13 overlaps the base point time frame and the elapsed time frame so that the distance between corresponding feature points in the base point time frame and the elapsed time frame becomes minimum. The overlapping unit 13 includes a minimum distance search unit 131. The minimum distance search unit 131 includes a moving unit 1311.

The minimum distance search unit 131 receives input of a base point time frame and information on a features amount and a pixel of a feature point in the base point time frame, from the base point time feature point detection unit 123. When there are a plurality of feature points, information on each of the plurality of feature points is input to the minimum distance search unit 131.

The moving unit 1311 receives input of an elapsed time frame and information on a feature amount and a pixel of a feature point in the elapsed time frame, from the elapsed time feature point detection unit 124. When there are a plurality of feature points, information on each of the plurality of feature points is input to the moving unit 1311. When a feature point is detected for the plurality of elapsed time frames, the plurality of elapsed time frames, the elapsed time corresponding to each of the plurality of elapsed time frames, and information on the feature point in each of the plurality of elapsed time frames are input.

The minimum distance search unit 131 searches for a corresponding feature point between the base point time frame and the elapsed time frame. Specifically, the minimum distance search unit 131 searches for a feature point having a feature amount similar between the elapsed time frame and the base point time frame.

The search for feature points by the minimum distance search unit 131 will be described with reference to FIGS. 2A and 2B.

In FIG. 2A, it is assumed that two feature points (feature point A and feature point B) are detected in the base point time frame. In FIG. 2B, it is assumed that two feature points (feature point A′ and feature point B′) are detected in the elapsed time frame. The minimum distance search unit 131 detects, for example, the feature point A′ as a feature point whose feature amount is most similar to the feature point A, and detects the feature point B′ as a feature point whose feature amount is most similar to the feature point B.

When the number of feature points in the elapsed time frame is smaller than the number of feature points in the base point time frame, the minimum distance search unit 131 searches for a corresponding feature point in the base point time frame and the elapsed time frame in accordance with the number of feature points in the elapsed time frame. Also, when the number of feature points in the elapsed time frame is larger than the number of feature points in the base point time frame, the minimum distance search unit 131 searches for a a corresponding feature point in the base point time frame and the elapsed time frame in accordance with the number of feature points in the base point time frame. That is, the minimum distance search unit 131 searches for a corresponding feature point in the base point time frame and the elapsed time frame in accordance with the smaller one of the number of feature points in the base point time frame and the number of feature points in the elapsed time frame.

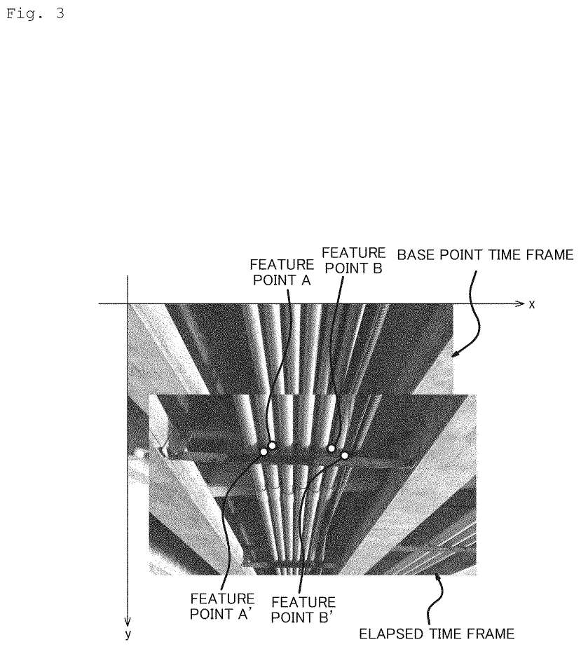

Next, as shown in FIG. 3, the minimum distance search unit 131 sets a coordinate system (xy coordinate system) with reference to the base point time frame, and, by means of the moving unit 1311, moves the elapsed time frame in the x-axis direction and the y-axis direction so that the distance between feature points corresponding to the base point time frame and the elapsed time frame (Euclidean distance) is minimized. The minimum distance search unit 131 fixes the elapsed time frame at a place where the Euclidean distance becomes minimum. If there are a plurality of elapsed time frames, the minimum distance search unit 131 performs the above-described processing on each elapsed time frame.

Referring again to FIG. 1, when the base point time frame and the elapsed time frame are overlapped so that the distance between the corresponding feature points is minimized, the overlapping unit 13 outputs information on the positions of the base point time frame and the elapsed time frame fixed on the coordinate axes to the overlap ratio determination unit 14.

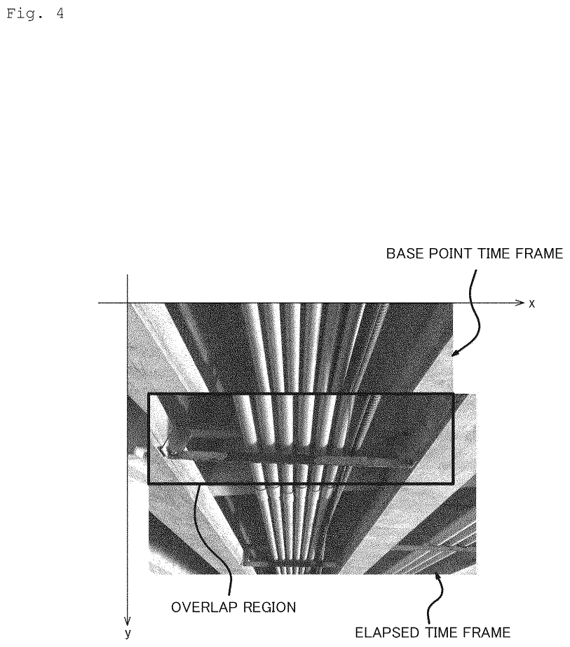

The overlap ratio determination unit 14 calculates the area (pixel area) of an overlap region where the base point time frame and the elapsed time frame overlap, as shown in FIG. 4, based on the information output from the overlapping unit 13. Then, the overlap ratio determination unit 14 determines whether or not a ratio (overlap ratio) of the area of the overlap region to the area of the base point time frame is equal to or less than a predetermined threshold value. When it is determined that the overlap ratio is equal to or less than the predetermined threshold value, the overlap ratio determination unit 14 outputs an elapsed time frame (a frame at time t1+Δt) as a cut-out frame to the storage unit 15 and stores the cut-out frame therein. On the other hand, when it is determined that the overlap ratio is not equal to or less than the predetermined threshold value, the overlap ratio determination unit 14 does not output the elapsed time frame to the storage unit 15 (does not store it therein).

When the ratio (overlap ratio) of the area of the overlap region to the area of the base point time frame is equal to or less than the predetermined threshold value, it is considered that a predetermined portion of the object within the field angle is moved by a predetermined amount between the base point time (time t1) and the elapsed time (time t1+Δt).

Therefore, when the ratio of the area of the overlap region to the area of the base point time frame becomes equal to or less than the predetermined threshold value, the image processing apparatus 10 according to the present embodiment outputs the elapsed time frame to the storage unit 15 and stores the elapsed time frame therein. In this manner, in a moving image obtained by photographing the object while moving the viewpoint, a frame at a timing when a predetermined portion of the object is displaced by a predetermined amount can be output.

When the overlap ratio determination unit 14 causes the storage unit 15 to store the elapsed time frame (frame at time t1+Δt) as a cut-out frame, the overlap ratio determination unit 14 notifies the base point time frame storage unit 121 that the elapsed time frame has been stored. The base point time frame storage unit 121 receives the notification from the overlap ratio determination unit 14, and repeats the above processing with a time 2 after the time t1+Δt as a new base point time. That is, when the elapsed time frame is output (stored) as a cut-out frame, the base point time frame storage unit 121 (feature point detection unit 12) determines a time following a time corresponding to the elapsed time frame as a new base point time, and extracts, from the input moving image, a frame of the time as a new base point time frame.

Thus, it is possible to prevent the processing from returning to the past from the base point time and duplicate processing from being repeated.

When the elapsed time frame at the time t1+Δt is not stored in the storage unit 15 as a cut-out frame, the above processing is repeated with a frame at the time t1+Δt1 following the time t1+Δt as the elapsed time frame.

Next, the operation of the image processing apparatus 10 according to the present embodiment will be described.

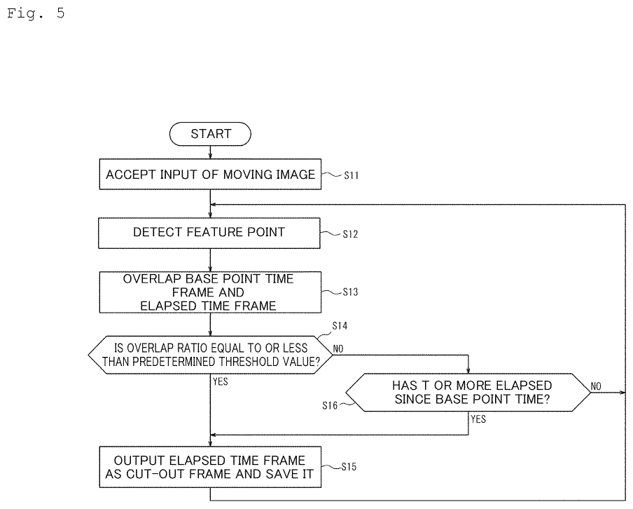

FIG. 5 is a flowchart showing an example of the operation of the image processing apparatus 10 according to the present embodiment, and is a diagram for explaining an image processing method by the image processing apparatus 10.

The moving image input unit 11 receives input of a moving image obtained by photographing an object while moving a viewpoint (step S11).

The feature point detection unit 12 detects a feature point in each of the base point time frame (first frame) at the base point time (first time) and the elapsed time frame (second frame) at the elapsed time (second time) at which a predetermined time has elapsed since the base point time (step S12). Specifically, the base point time frame storage unit 121 extracts the base point time frame from the input moving image and stores the base point time frame. The elapsed time frame storage unit 122 extracts the elapsed time frame from the input moving image and stores the elapsed time frame. Then, the base point time feature point detection unit 123 detects a feature point in the stored base point time frame. The elapsed time feature point detection unit 124 detects a feature point in the stored elapsed time frame.

The overlapping unit 13 overlaps the base point time frame and the elapsed time frame so that the distance between corresponding feature points in the base point time frame and the elapsed time frame becomes minimum (step S13).

Specifically, the minimum distance search unit 131 searches for a feature point in the base point time frame and a feature point in the elapsed time frame that corresponds to the feature point in the base point time frame. Then, the minimum distance search unit 131 moves the elapsed time frame on coordinates having the base point time frame as a reference, by means of the moving unit 1311, so that the Euclidean distance between the corresponding feature points becomes minimum, and then overlaps the base point time frame and the elapsed time frame.

The overlap ratio determination unit 14 calculates the area of an overlap region where the base point time frame and the elapsed time frame overlap. Then, the overlap ratio determination unit 14 determines whether or not the ratio (overlap ratio) of the area of the overlap region to the area of the base point time frame is equal to or less than a predetermined threshold value (step S14).

When it is determined that the overlap ratio is equal to or less than the predetermined threshold value (step S14: Yes), the overlap ratio determination unit 14 outputs the elapsed time frame as a cut-out frame to the storage unit 15 and stores it therein (step S15). After the elapsed time frame is stored in the storage unit 15 as a cut-out frame, the base point time is updated, and processing is repeated from step S12. Specifically, the base point time is updated, and processing after step S12 is performed for a new base point time frame and an elapsed time frame.

When it is determined that the overlap ratio is not equal to or less than the threshold value (step S14: No), the overlap ratio determination unit 14 determines whether or not a predetermined threshold value T or more has elapsed from the base point time, that is, whether or not an elapsed time from the base point time to the elapsed time is T or more (step S16).

When it is determined that the predetermined threshold value T or more has elapsed from the base point time (step S16: Yes), the overlap ratio determination unit 14 outputs the elapsed time frame as a cut-out frame to the storage unit 15 and stores it therein (step S15). As a result, even when an error or the like occurs in image recognition, the processing is prevented from being terminated without having the cut-out frame stored at all.

When it is determined that the predetermined threshold value T or more has not elapsed from the base point time (step S16: No), the overlap ratio determination unit 14 notifies the base point time frame storage unit 121 that the elapsed time frame is not stored as a cut-out frame. With this notification, the processing is repeated from step S12. Specifically, the elapsed time is updated, and the processing after step S12 is performed for the base point time frame and the new elapsed time frame.

Next, a hardware configuration of the image processing apparatus 10 according to the present embodiment will be described.

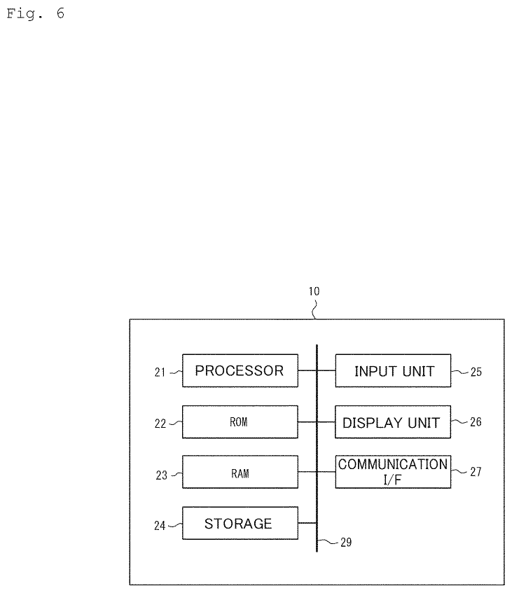

FIG. 6 is a diagram showing an example of a hardware configuration of the image processing apparatus 10 according to the present embodiment. FIG. 6 shows an example of the hardware configuration of the image processing apparatus 10 where the image processing apparatus 10 is constituted by a computer capable of executing a program instruction. The computer may be any of a general-purpose computer, a dedicated computer, a workstation, a PC (Personal Computer), an electronic note pad, or the like. The program instructions may be program codes, code segments, or the like for executing necessary tasks.

As shown in FIG. 6, the image processing apparatus 10 includes a processor 21, a ROM (Read Only Memory) 22, a RAM (Random Access Memory) 23, a storage 24, an input unit 25, a display unit 26, and a communication interface (I/F) 27. The respective components are connected to each other via a bus 29 so as to be mutually communicable. Specifically, the processor 21 may be any of a CPU (Central Processing Unit), an MPU (Micro Processing Unit), a GPU (Graphics Processing Unit), a DSP (Digital Signal Processor), a SOC (System on a Chip), or the like, and may be constituted by a plurality of processors of the same kind or different kinds.

The processor 21 is a controller for controlling each component and executing various types of arithmetic processing. That is, the processor 21 reads a program from the ROM 22 or the storage 24 and executes the program using the RAM 23 as a work area. The processor 21 performs control of each component and various types of arithmetic processing according to programs stored in the ROM 22 or the storage 24. In the present embodiment, the ROM 22 or the storage 24 stores a program for causing a computer to operate as the image processing apparatus 10 according to the present disclosure. The program is read out and executed by the processor 21, so that each component of the image processing apparatus 10, that is, the feature point detection unit 12, the overlapping unit 13, and the overlap ratio determination unit 14 are realized.

The program may be provided by being stored on a non-transitory storage medium such as a CD-ROM (Compact Disk Read Only Memory), a DVD-ROM (Digital Versatile Disk Read Only Memory), or a USB (Universal Serial Bus) memory. Further, the program may be downloaded from an external device via a network.

The ROM 22 stores various programs and various types of data. The RAM 23 temporarily stores programs or data as a working area. The storage 24 is configured of an HDD (Hard Disk Drive) or an SSD (Solid State Drive), and stores various programs including an operating system and various types of data. The ROM 22 or the storage 24 stores, for example, the elapsed time frame that is as a cut-out frame.

The input unit 25 includes a pointing device such as a mouse and a keyboard, and is used for various inputs.

The display unit 26 is, for example, a liquid crystal display, and displays various types of information. A touch panel system may be employed as the display unit 26, which may function as the input unit 25.

The communication interface 27 is an interface for performing communication with other devices (such as a photographing device that captures a moving image), and examples thereof include an interface for LAN.

A computer can be suitably used to function as each unit of the image processing apparatus 10 described above. Such a computer can be realized by storing a program describing the details of processing for realizing the functions of the respective units of the image processing apparatus 10 in a storage unit of the computer and allowing a processor of the computer to read and execute the program. That is, the program can cause the computer to function as the above-described image processing apparatus 10. Further, the program can be recorded on a non-transitory recording medium. The program may also be provided via a network.

As described above, the image processing apparatus 10 according to the present embodiment includes the feature point detection unit 12, the overlapping unit 13, and the overlap ratio determination unit 14. The feature point detection unit 12 detects a feature point in each of a base point time frame at a base point time and an elapsed time frame at an elapsed time when a predetermined time has elapsed from the base point time. The overlapping unit 13 overlaps the base point time frame and the elapsed time frame so that the distance between corresponding feature points in the base point time frame and the elapsed time frame becomes minimum. The overlap ratio determination unit 14 determines whether or not the ratio (overlap ratio) of the area of the overlap region where the base point time frame and the elapsed time frame overlap with respect to the area of the base point time frame is equal to or less than a predetermined threshold value, and outputs the elapsed time frame as a cut-out frame when determining that the overlap ratio is equal to or less than the predetermined threshold value.

When the area of the overlap region with respect to the area of the base point time frame is equal to or less than the predetermined threshold value, it is considered that a predetermined portion of the object within the angle of view has moved by a predetermined amount between the base point time and the elapsed time. Therefore, when the ratio of the area of the overlap region to the area of the base point time frame becomes equal to or less than the predetermined threshold value, the image processing apparatus 10 according to the present embodiment outputs the elapsed time frame as a cut-out frame. In this manner, in a moving image obtained by photographing the object while moving the viewpoint, a frame at a timing when a predetermined portion of the object is displaced by a predetermined amount can be output.

### Second Embodiment

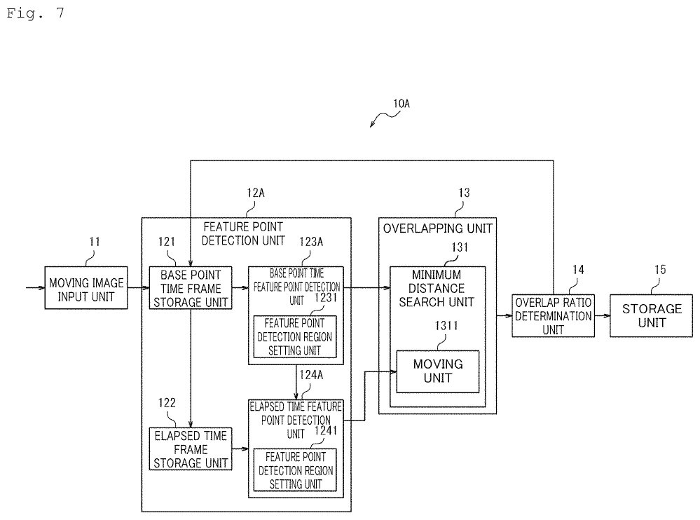

FIG. 7 is a diagram showing an example of a configuration of an image processing apparatus 10A according to a second embodiment of the present disclosure.

The image processing apparatus 10A shown in FIG. 7 is different from the image processing apparatus 10 shown in FIG. 1 in that the feature point detection unit 12 is changed to a feature point detection unit 12A. The feature point detection unit 12A differs from the feature point detection unit 12 in that the base point time feature point detection unit 123 is changed to a base point time feature point detection unit 123A and that the elapsed time feature point detection unit 124 is changed to an elapsed time feature point detection unit 124A. The base point time feature point detection unit 123A includes a feature point detection region setting unit 1231. The elapsed time feature point detection unit 124A includes a feature point detection region setting unit 1241.

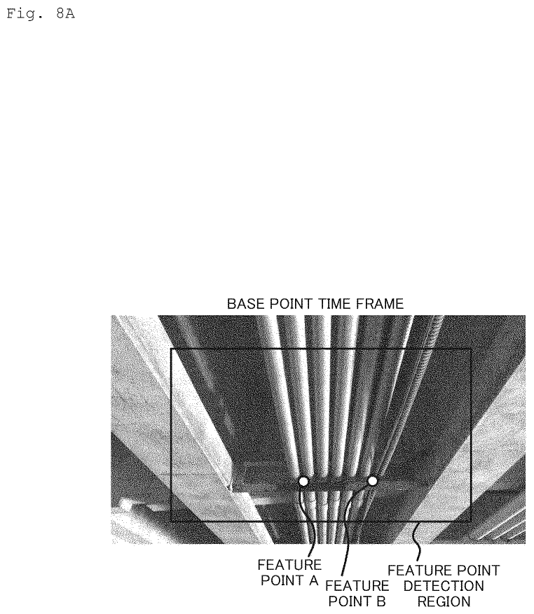

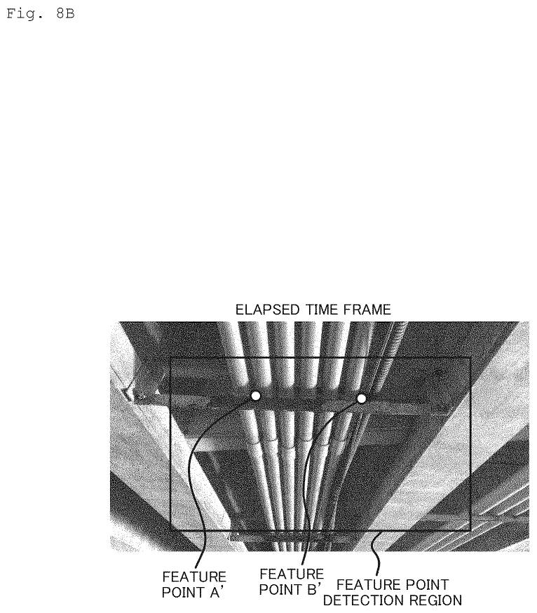

The feature point detection region setting unit 1231 sets a feature point detection region which is a region for detecting a feature point in the base point time frame as shown in FIG. 8A. The feature point detection region setting unit 1231 sets a feature point detection region in response to an input from user through the input unit 25, for example. The base point time feature point detection unit 123A detects a feature point in a feature point detection region set by the feature point detection region setting unit 1231 in the base point time frame.

The feature point detection region setting unit 1241 sets a feature point detection region which is a region for detecting a feature point in the elapsed time frame as shown in FIG. 8B. The feature point detection region setting unit 1241 sets a feature point detection region in response to an input from a user through the input unit 25, for example. The elapsed time feature point detection unit 124A detects a feature point in a feature point detection region set by the feature point detection region setting unit 1241 in the elapsed time frame.

Although FIGS. 8A and 8B shows an example in which a feature point detection region is rectangular, the present invention is not limited thereto, and the feature point detection region may be set in any shape.

Thus, in the present embodiment, the feature point detection unit 12A sets a feature point detection region which is a region for detecting a feature point in a frame (base point time frame and elapsed time frame), and detects a feature point in the feature point detection region set for each of the base point time frame and the elapsed time frame.

By setting the feature point detection region, it is possible to prevent the feature point detected in the base point time frame from missing in the elapsed time frame due to movement of the viewpoint of the photographing device. For example, in a case where a feature point is detected by a pixel close to an end of the frame in the base point time frame, the viewpoint of the photographing device moves, and therefore it is highly likely that said feature point is not photographed in the elapsed time frame. Thus, in a case where the central part of the frame or the photographing device captures while moving in a fixed direction, it is effective that a region in the next frame where the object exists is set as the feature point detection region.

### Third Embodiment

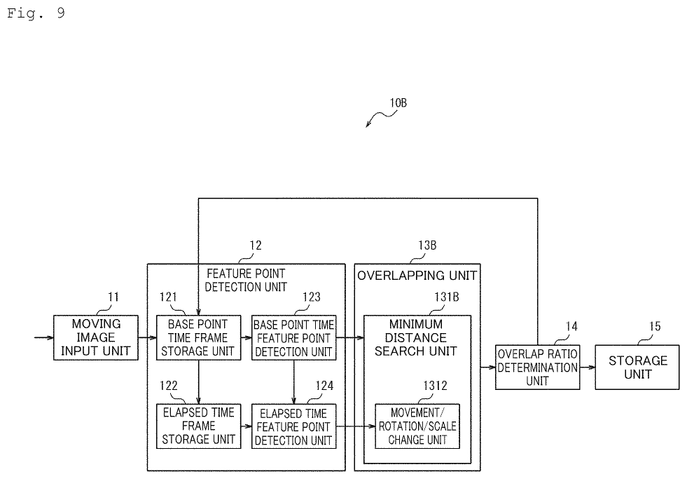

FIG. 9 is a diagram showing an example of a configuration of an image processing apparatus 10B according to a third embodiment of the present disclosure.

The image processing apparatus 10B shown in FIG. 9 differs from the image processing apparatus 10 shown in FIG. 1 in that the overlapping unit 13 is changed to an overlapping unit 13B. The overlapping unit 13B is different from the overlapping unit 13 in that the minimum distance search unit 131 is changed to a minimum distance search unit 131B. The minimum distance search unit 131B is different from the minimum distance search unit 131 in that the moving unit 1311 is changed to a movement/rotation/scale change unit 1312.

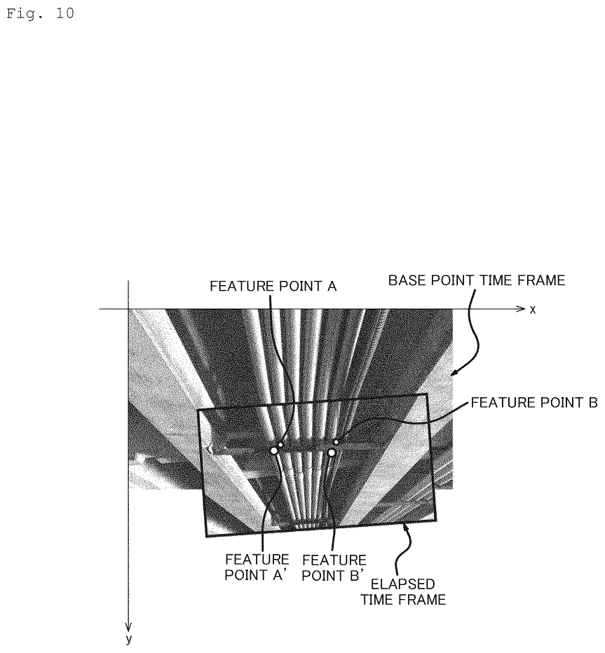

The movement/rotation/scale change unit 1312 rotates the elapsed time frame as shown in FIG. 10 when moving the elapsed time frame on coordinates with reference to the base point time frame, and/or changes the scale of the elapsed time frame, so that the distance between corresponding feature points in the base point time frame and the elapsed time frame becomes minimum. That is, the overlapping unit 13B rotates the elapsed time frame and/or changes the scale of the elapsed time frame, and overlaps the base point time frame and the elapsed time frame so that the distance between corresponding feature points in the base point time frame and the elapsed time frame is minimized.

By rotating the elapsed time frame, the position of the feature point in the elapsed time frame is also changed in accordance with the rotation of the elapsed time frame. In addition, by changing (enlarging or reducing) the scale of the elapsed time frame, the position of the feature point in the elapsed time frame is also changed in accordance with the enlargement or reduction of the elapsed time frame.

Therefore, in a case where an object is captured by the photographing device while the viewpoint of the photographing device rotates, and in a case where the image is taken at an angle at a certain elevation angle to the object, an error in overlap of the corresponding feature points between the base point time frame and the elapsed time frame can be reduced. As a result, the accuracy of the overlap ratio determination is improved, and the occurrence of overlap and omission of a frame stored as a cut-out frame can be suppressed.

Although the present embodiment has been described by using an example in which the overlapping unit 13 of the image processing apparatus 10 according to the first embodiment is changed to the overlapping unit 13B, the present invention is not limited thereto. The overlapping unit 13 of the image processing apparatus 10A according to the second embodiment may be changed to the overlapping unit 13B.

### Fourth Embodiment

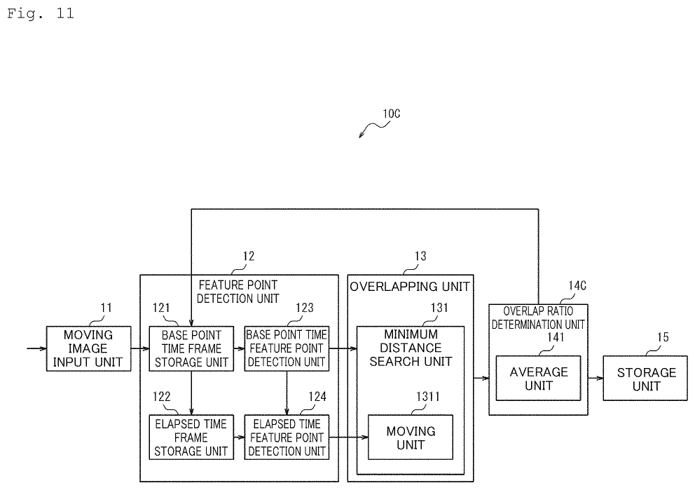

FIG. 11 is a diagram showing an example of a configuration of an image processing apparatus 10C according to a fourth embodiment of the present disclosure.

The image processing apparatus 10C shown in FIG. 11 differs from the image processing apparatus 10 shown in FIG. 1 in that the overlap ratio determination unit 14 is changed to an overlap ratio determination unit 14C. The overlap ratio determination unit 14C includes an average unit 141.

The average unit 141 calculates an average value of the areas of overlap regions between the base point time frame and each of elapsed time frames at a plurality of elapsed times different in terms of the elapsed time from the base point time. For example, when the time t1 is used as the base point time, the average unit 141 calculates the areas of the overlap regions between the base point time frame and an elapsed time frame at the time t1 +Δ as well as elapsed time frames at the time t1+Δt1, t1+Δt2, t1+Δt3. Then, the average unit 141 calculates the average value of the areas of the overlap regions between the base point time frame and each of the elapsed time frames at the times t1+Δ, t1+Δt1, t1+Δt2, t1+Δt3. The number of elapsed time frames for calculating the average value of the areas of the overlap regions overlapping with the base point time frame may be any number equal to or greater than two.

The overlap ratio determination unit 140 determines whether or not the ratio of the average value of the areas of the overlap regions between the base point time frame and each of the plurality of elapsed time frames calculated by the average unit 141 with respect to the area of the base point time frame is equal to or less than a predetermined threshold value. When it is determined that the ratio between the area of the base point time frame and the average value of the areas of the overlap regions between the base point time frame and each of the plurality of elapsed time frames is equal to or less than the predetermined threshold value, the overlap ratio determination unit 14C outputs at least one elapsed time frame among the plurality of elapsed time frames to the storage unit 15 as a cut-out frame, and stores the elapsed time frame therein.

By using the average value of the overlap regions between the base point time frame and the plurality of elapsed time frames, the occurrence of an error due to an error of image recognition for one frame can be suppressed.

Although the present embodiment has been described using an example in which the overlap ratio determination unit 14 of the image processing apparatus 10 according to the first embodiment is changed to the overlap ratio determination unit 14C, the present invention is not limited thereto. The overlap ratio determination unit 14 of the image processing apparatus 10A according to the second embodiment or of the image processing apparatus 10B according to the third embodiment may be changed to the overlap ratio determination unit 14C.

The image processing apparatus 10A according to the second embodiment, the image processing apparatus 10B according to the third embodiment, and the image processing apparatus 10C according to the fourth embodiment can also be constituted by a computer having the hardware configuration described with reference to FIG. 6.

The following addenda are disclosed in relation to the embodiments described above.

### Addendum 1

An image processing apparatus that outputs, as a cut-out frame, a frame at a timing when a predetermined portion of an object is displaced by a predetermined amount in a moving image consisting of a plurality of frames and obtained by photographing the object while moving a viewpoint, the image processing apparatus comprising:
a memory; and
a control unit connected to the memory,
wherein the control unit is configured to:
detect feature points in a first frame that is a frame at a first time serving as a base point and a second frame that is a frame at a second time after a predetermined time has elapsed from the first time;
overlap the first frame and the second frame so that a distance between corresponding feature points in the first frame and the second frame is minimized; and
determine whether or not a ratio of an area of an overlap region where the first frame and the second frame overlap, to an area of the first frame, is equal to or less tha a predetermined threshold value, and output the second frame as the cut-out frame if the ratio is determined to be equal to or less than the predetermined threshold value.

### Addendum 2

The image processing apparatus according to addendum 1, wherein
the control unit sets a feature point detection region that is a region where the feature point is detected in the frame, and detects the feature point in the set feature point detection region.

### Addendum 3

The image processing apparatus according to addendum 1, wherein
the control unit rotates the second frame and/or changes a scale of the second frame, and overlaps the first frame and the second frame so that the distance is minimized.

### Addendum 4

The image processing apparatus according to addendum 1, wherein
the control unit calculates an average value of areas of overlap regions between the first frame and the second frame at each of a plurality of times different from the time serving as the base point in terms of elapsed time, determines whether or not a ratio of the average value to the area of the first frame is equal to or less than the predetermined threshold value, and outputs at least one elapsed time frame among the plurality of second frames as the cut-out frame if the ratio is determined to be equal to or less than the predetermined threshold value.

### Addendum 5

The image processing apparatus according to addendum 1, wherein
when the second frame is output as the cut-out frame, the control unit determines a time following a time corresponding to the second frame as a time serving as the base point, and extracts, from the moving image, a frame at the time as the first frame.

### Addendum 6

An image processing method for outputting, as a cut-out frame, a frame at a timing when a predetermined portion of an object is displaced by a predetermined amount in a moving image consisting of a plurality of frames and obtained by photographing the object while moving a viewpoint, the image processing method comprising the steps of:
detecting feature points in a first frame that is a frame at a first time and a second frame that is a frame at a second time after a predetermined time has elapsed from the first time;
overlapping the first frame and the second frame so that a distance between corresponding feature points in the first frame and the second frame is minimized; and
determining whether or not a ratio of an area of an overlap region where the first frame and the second frame overlap, to an area of the first frame, is equal to or less than a predetermined threshold value, and outputting the second frame as the cut-out frame if the ratio is determined to be equal to or less than the predetermined threshold value.

### Addendum 7

A non-transitory storage medium that stores a program executable by a computer, the non-transitory storage medium causing the computer to operate as the image processing apparatus described in addendum 1 and storing a program.

Although the above embodiments are described as representative example, it is clear to those skilled in the art that many changes and substitutions can be made within the gist and scope of the present disclosure. Therefore, the embodiment described above should not be interpreted as limiting and the present invention can be modified and changed in various ways without departing from the scope of the claims. For example, a plurality of configuration blocks shown in the configuration diagrams of the embodiments may be combined to one, or one configuration block may be divided.

### REFERENCE SIGNS LIST

10, 10A, 10B, 10C Image processing apparatus
11 Moving image input unit
12, 12A Feature point detection unit
13, 13B Overlapping unit
14, 14C Overlap ratio determination unit
15 Storage unit
121 Base point time frame storage unit
122 Elapsed time frame storage unit
123, 123A Base point time feature point detection unit
124, 124A Elapsed time feature point detection unit
131, 131B Minimum distance search unit
141 Average unit
1231, 1241 Feature point detection region setting unit
1311 Moving unit
1312 Movement/rotation/scale change unit
21 Processor
22 ROM
23 RAM
24 Storage
25 Input unit
26 Display unit
27 Communication I/F
29 Bus

1. An image processing apparatus that outputs, as a cut-out frame, a frame at a timing when a predetermined portion of an object is displaced by a predetermined amount in a moving image consisting of a plurality of frames and obtained by photographing the object while moving a viewpoint, the image processing apparatus comprising:
a feature point detection unit configured to detect feature points in a first frame that is a frame at a first time serving as a base point and a second frame that is a frame at a second time after a predetermined time has elapsed from the first time;
an overlapping unit configured to overlap the first frame and the second frame so that a distance between corresponding feature points in the first frame and the second frame is minimized; and
an overlap ratio determination unit configured to determine whether or not a ratio of an area of an overlap region where the first frame and the second frame overlap, to an area of the first frame, is equal to or less than a predetermined threshold value, and output the second frame as the cut-out frame if the ratio is determined to be equal to or less than the predetermined threshold value.

2. The image processing apparatus according to claim 1, wherein
the feature point detection unit sets a feature point detection region that is a region where the feature point is detected in the frame, and detects the feature point in the set feature point detection region.

3. The image processing apparatus according to claim 1, wherein
the overlapping unit rotates the second frame and/or changes a scale of the second frame, and overlaps the first frame and the second frame so that the distance is minimized.

4. The image processing apparatus according to claim 1, wherein
the overlap ratio determination unit calculates an average value of areas of overlap regions between the first frame and the second frame at each of a plurality of times different from the time serving as the base point in terms of elapsed time, determines whether or not a ratio of the average value to the area of the first frame is equal to or less than the predetermined threshold value, and outputs at least one elapsed time frame among the plurality of second frames as the cut-out frame if the ratio is determined to be equal to or less than the predetermined threshold value.

5. The image processing apparatus according to claim 1, wherein
when the second frame is output as the cut-out frame, the feature point detection unit determines a time following a time corresponding to the second frame as a time serving as the base point, and extracts, from the moving image, a frame at the time as the first frame.

6. An image processing method for outputting, as a cut-out frame, a frame at a timing when a predetermined portion of an object is displaced by a predetermined amount in a moving image consisting of a plurality of frames and obtained by photographing the object while moving a viewpoint, the image processing method comprising the steps of:
detecting feature points in a first frame that is a frame at a first time and a second frame that is a frame at a second time after a predetermined time has elapsed from the first time;
overlapping the first frame and the second frame so that a distance between corresponding feature points in the first frame and the second frame is minimized; and
determining whether or not a ratio of an area of an overlap region where the first frame and the second frame overlap, to an area of the first frame, is equal to or less than a predetermined threshold value, and outputting the second frame as the cut-out frame if the ratio is determined to be equal to or less than the predetermined threshold value.

7. (canceled)

8. The image processing method according to claim 6, comprising:
setting a feature point detection region that is a region where the feature point is detected in the frame and detecting the feature point in the set feature point detection region.

9. The image processing method according to claim 6, comprising:
rotating the second frame and/or changes a scale of the second frame and overlapping the first frame and the second frame so that the distance is minimized.

10. The image processing method according to claim 6, comprising:
calculating an average value of areas of overlap regions between the first frame and the second frame at each of a plurality of times different from the time serving as the base point in terms of elapsed time;
determining whether or not a ratio of the average value to the area of the first frame is equal to or less than the predetermined threshold value; and
outputting at least one elapsed time frame among the plurality of second frames as the cut-out frame if the ratio is determined to be equal to or less than the predetermined threshold value.

11. The image processing method according to claim 6, comprising:
when the second frame is output as the cut-out frame, a time following a time corresponding to the second frame is determined as a time serving as the base point; and
extracting, from the moving image, a frame at the time as the first frame.

12. A computer-readable non-transitory recording medium storing computer-executable program instructions that when executed by a processor cause a computer to execute a program generation method comprising:
detecting feature points in a first frame that is a frame at a first time serving as a base point and a second frame that is a frame at a second time after a predetermined time has elapsed from the first time;
overlapping the first frame and the second frame so that a distance between corresponding feature points in the first frame and the second frame is minimized; and
determining whether or not a ratio of an area of an overlap region where the first frame and the second frame overlap, to an area of the first frame, is equal to or less than a predetermined threshold value, and output the second frame as the cut-out frame if the ratio is determined to be equal to or less than the predetermined threshold value.

13. The program generation method according to claim 12, comprising:
setting a feature point detection region that is a region where the feature point is detected in the frame and detecting the feature point in the set feature point detection region.

14. The program generation method according to claim 12, comprising:
rotating the second frame and/or changes a scale of the second frame and overlapping the first frame and the second frame so that the distance is minimized.

15. The program generation method according to claim 12, comprising:
calculating an average value of areas of overlap regions between the first frame and the second frame at each of a plurality of times different from the time serving as the base point in terms of elapsed time;
determining whether or not a ratio of the average value to the area of the first frame is equal to or less than the predetermined threshold value; and
outputting at least one elapsed time frame among the plurality of second frames as the cut-out frame if the ratio is determined to be equal to or less than the predetermined threshold value.

16. The program generation method according to claim 12, comprising:
when the second frame is output as the cut-out frame, a time following a time corresponding to the second frame is determined as a time serving as the base point; and
extracting, from the moving image, a frame at the time as the first frame.

17. The image processing apparatus according to claim 1, further comprising:
extracting the second frame from the input moving image; and
detecting the feature points in the first frame.

18. The image processing apparatus according to claim 1, further comprising:
superimposing the first frame and the second frame wherein the distance between corresponding feature points in the first frame and the second frame are minimized.

19. The image processing apparatus according to claim 18, further comprising:
moving the second frame on coordinates based on the first frame wherein a Euclidean distance between the corresponding feature points is minimized.

20. The image processing apparatus according to claim 1, further comprising:
determining the overlap rate is not equal to or less than the threshold, the overlap rate determination unit determines whether or not a predetermined threshold, wherein if it is determined that the predetermined threshold value or more has passed since the first time, the overlap rate determination unit outputs the elapsed time frame as a cut-out frame.

21. The image processing apparatus according to claim 20, wherein if the predetermined threshold has not passed the first time, the second frame is not stored as the cut-out frame.
